(19) United States
(12) Patent Application Publication
(10) Pub. No.: US 2016/0219918 A1
(43) Pub. Date: Aug. 4, 2016

(54) PROCESSED CITRUS FRUIT RAW JUICE OR THE CONCENTRATE THEREOF, THEIR PREPARATION METHOD AND PRODUCTS COMPRISING THE SAME

(71) Applicant: YANG SHENG TANG COMPANY LIMITED, Haikou City (CN)

(72) Inventor: Yonghui SHI, Haikou City (CN)

(21) Appl. No.: 15/003,493

(22) Filed: Jan. 21, 2016

Related U.S. Application Data
(63) Continuation of application No. 13/925,296, filed on Jun. 24, 2013, now abandoned.
Application No. 13/925,296 is a division of application No. 13/144,453, filed on Jul. 13, 2011, now abandoned.

(30) Foreign Application Priority Data
Jan. 13, 2009 (CN) 200910000665.1

(51) Int. Cl. A23L 2/10; A23L 2/46; A23L 2/68; A23L 2/06

(52) U.S. Cl. CPC A23L 2/10; A23L 2/06; A23L 2/46; A23L 2/68; A23V 2002/00

(57) ABSTRACT

The techniques disclosed herein relate to processed citrus fruit raw juice or the concentrate thereof, the preparation thereof, products comprising them, and uses thereof in the manufacture of various edible products.

### CROSS REFERENCE TO RELATED APPLICATIONS

This application is a Continuation of U.S. patent application Ser. No. 13/925,296 filed Jun. 24, 2013, which is a Divisional of U.S. patent application Ser. No. 13/144,453, filed Jul. 13, 2011, which is the National Stage of International Patent Application of PCT/CN2010/000039, filed Jan. 11, 2010, which claims the benefit of Chinese Patent Application Serial No. 200910000665.1, filed Jan. 13, 2009, each of which is hereby incorporated by reference in its entirety.

### TECHNICAL FIELD

The techniques disclosed herein relate to processed citrus fruit raw juice or the concentrate thereof, including their preparation, the products comprising them, and their uses in the manufacture of various edible products.

### BACKGROUND

The term “citrus fruit” is the general term for orange and tangerine fruit. Orange fruit and tangerine fruit are abundant in vitamins and moderate in sweetness and sourness, and are fruits often consumed in daily life. Orange juice from citrus fruits is needed in large amount in daily life. The juice is generally obtained from oranges specifically used for orange juice production, such as a Hamlin orange, which has a relatively high acidity and cannot be consumed. In addition, the orange juice processed using Hamlin oranges has a sugar-acid ratio of no greater than 12:1. A Navel orange is a kind of “C. sinensis Osbeck,” referring to the general term of oranges with a navel-like shape on the bottom, mainly including: the Newhall navel orange, Bonanza navel orange, Forst nucallar navel oranges, Robertson 35# navel orange, Huahong (Changhong) navel orange, and Navelina navel orange.

Although large quantities of oranges are brought to the market in harvest seasons each year, a significant amount of the navel oranges would need to be processed (i.e. citrus fruits including navel oranges are processed into the juice or puree) due to problems in terms of transportation, preservation, price variation, and the appearance of the navel oranges, as well as market demand for orange juice products. However, citrus fruits such as navel oranges contain limonin or limonin precursors that may generate more limonin during the processing procedures, resulting in bitterness in the processed juice. In addition, during the course of processing citrus fruits such as navel oranges, unfavorable odors may be generated when heating citrus fruits such as navel oranges. Due to the bitterness and unfavorable odors, citrus fruits such as navel oranges cannot be used for orange juice production, leading to the consequence that large quantities of citrus fruits such as navel oranges are discarded as not being able to be consumed or processed in time, thereby causing a great economic loss for regions producing these citrus fruits such as navel oranges.

### DETAILED DESCRIPTION

Throughout the description, for the purposes of explanation, numerous specific details are set forth in order to provide a thorough understanding of the present invention. It will be apparent to one skilled in the art, however, that the present invention may be practiced without some of these specific details. In other instances, well-known structures and devices are shown in block diagram form to avoid obscuring the underlying principles of embodiments of the invention.

Technical industrial methods and apparatuses are described for processing citrus fruits, especially navel oranges, into citrus fruit raw juice substantial free of bitterness and unfavorable odor. After comprehensive and intensive research, it has been found that the bitterness and unfavorable odor of the citrus fruit raw juice or puree processed from citrus fruit, such as navel orange, can be removed by adding an acid harmless to human and simultaneously performing a physical treatment while processing the citrus fruit, where the orange juice thus processed has a sugar-acid ratio of 14:1 to 25:1.

The first aspect of the disclosed techniques relates to processed citrus fruit raw juice or the concentrate thereof, characterized in that said raw juice or the concentrate thereof is substantially free of bitterness and unfavorable odor, and has a sugar-acid ratio of 14:1 to 25:1; preferably 14:1 to 20:1, or more preferably 14:1 to 18:1. Another aspect of the techniques disclosed herein relates to a product comprising processed citrus fruit raw juice or the concentrate thereof, where the product comprises processed citrus fruit raw juice or the concentrate thereof, or processed citrus fruit raw juice or the concentrate thereof as well as one or more edible substances, wherein the processed citrus fruit raw juice or the concentrate thereof is substantially free of bitterness and unfavorable odor and has a sugar-acid ratio of 14:1 to 25:1.

The disclosed techniques further relate to a method for producing citrus fruit raw juice or the concentrate thereof, comprising: (a) squeezing a citrus fruit with a squeezer to produce citrus fruit raw juice or puree, simultaneously adding an acid harmless to human so that the squeezed citrus fruit raw juice or puree has a total acid content of 0.85-1.0 wt %; b) heating the citrus fruit raw juice obtained in (a) at 75° C.±5° C. to 80° C.±2° C. for 30±10 to 60±5 seconds, to obtain fruit raw juice that is substantially free of bitterness and unfavorable smell and has a sugar-acid ratio of 14:1 to 25:1; and c) if necessary, further concentrating the citrus fruit raw juice in (b) according to a conventional method to a volume that is ½- 1/10 (preferably ½-⅙ or more preferably ¼-⅙) the volume of the citrus fruit raw juice to obtain a concentrate of citrus fruit juice.

Another aspect of the techniques described herein relates to a use of a processed citrus fruit raw juice or the concentrate thereof in the manufacture of an edible product, wherein the processed citrus fruit raw juice or the concentrate thereof is substantially free of bitterness and unfavorable odor, and has a sugar-acid ratio of 14:1 to 25:1 (preferably 14-20:1, or more preferably 14-18:1). The disclosed techniques further relate to a use of an acid harmless to human in processing a citrus fruit such as a navel orange.

### DEFINITION OF TERMS

In the techniques disclosed herein, citrus fruit refers to the general term for tangerine fruit and orange fruit, without special limitation on the place of production and variety, as long as bitterness or an unfavorable odor is generated when during processing by conventional methods for citrus fruits. The citrus fruit is preferably a navel orange, or more preferably a Newhall navel orange.

In the techniques disclosed herein, citrus fruit raw juice or puree refers to the juice or puree generated when a citrus fruit is squeezed or crushed. A conventional processing method refers to a common or known method in the art such as the field of citrus fruits processing, for example but not limited to, directly squeezing citrus fruit such as Hamlin orange and then treating at 98° C. for 30 seconds.

A concentrate of citrus fruit juice refers to a product obtained by concentrating a citrus fruit raw juice to a volume that is ½ to 1/10; preferably ½ to ⅙, or more preferably ¼ to 1/6 the volume of the citrus fruit raw juice. The sugar-acid ratio of citrus fruit is the ratio between the total sugar and the total acid in the citrus fruit.

The term “processed citrus fruit raw juice or the concentrate thereof” refers to a citrus fruit raw juice or the concentrate thereof obtained after treating a natural citrus fruit in the presence of an acid, the processed citrus fruit raw juice or concentrate having at least one of the following features: substantially free of bitterness, free of unfavorable odor, having a sugar-acid ratio of 14-25:1, preferably 14-20:1, or more preferably 14-18:1; or having a pH of 3.5 or less, preferably 3.4-3.1.

The term “product” is not specifically limited, usually comprising a processed citrus fruit raw juice or the concentrate thereof, or any form of product obtained by mixing a processed citrus fruit raw juice or concentrate with one or more other edible substances, for example, 100% citrus fruit juice, preferably 100% navel orange juice or concentrate; a mixed fruit juice of a citrus fruit raw juice or concentrate and one or more other fruit juice or puree, wherein said other fruit juice is, for example, but not limited to, orange juice not derived from a navel orange, apple juice, peach juice, vegetable juice, etc.

The term “an acid harmless to human” is not specifically limited, as long as it is not harmful for human body, it can be any acid allowed to be added in the food industry, including but not limited to, citric acid, malic acid, or preferably an acid present in citrus fruit itself, including but not limited to citric acid. The amount of the acid harmless to human is not specifically limited, as long as the amount added allows the total acid content of the squeezed citrus fruit raw juice to be 0.85-1.0 wt % or allows the processed citrus fruit raw juice to be free of unfavorable odor with a sugar-acid ratio of 14-25:1, preferably 14-20:1, or more preferably 14-18:1.

The following non-limiting examples are used to further illustrate the techniques disclosed herein.

### Example 1

### Preparation of a Navel Orange Raw Juice or the Concentrate Thereof Substantially Free of Bitterness and Unfavorable Odor

60 tons of Newhall navel oranges with a sugar-acid ratio of 20:1 were spray-washed, and then squeezed in a squeezer. The squeezed juice was fed into a cyclone separator to remove flat seeds in the juice. After removing the flat seeds, the juice was fed into a separator to separate the pulp; the separated clear juice was subjected to acidity assay, and the acidity was about 0.65 wt %. Then, citric acid was added so that the acidity of the clear juice was adjusted to become 0.95 wt %, the clear juice with an acidity of 0.95 wt % was fed into a sterilizer for sterilization. During sterilization, the clear juice described above was preheated to 58° C. for degassing; raising the temperature after degassing; keeping at 80° C. for sterilization and inactivation of enzymes; and after 30 seconds, it was cooled to below 15° C. Then, the clear juice obtained was placed and stored within 30 min in a −18° C. refrigerator. The orange juice produced by the above method was a raw juice, which was sampled for examination when cooled to 15° C., and the results showed that it was rich in orange flavor without unfavorable odor, and was substantially free of bitterness. The detected sugar-acid ratio was about 14.2:1, and the pH was 3.36. Then, 10,000 liters of the above obtained navel orange juice was vacuum concentrated to 2,500 liters using a conventional method of orange juice processing. After examination, the results showed that it was rich in orange flavor without unfavorable odor, and was substantially free of bitterness; the sugar-acid ratio was about 14.2:1, and the pH was about 3.1.

### Comparative Example 1

### Navel Orange Raw Juice or the Concentrate Thereof Processed using Conventional Method

20 kg of Newhall navel orange with a sugar-acid ratio of 20:1 was washed, and then squeezed in a squeezer. The squeezed juice was fed into a cyclone separator to remove flat seeds in the juice. After removing flat seeds, the juice was fed into a separator to separate the pulp; the separated clear juice was fed into a sterilizer for sterilization. During sterilization, the clear juice was preheated to 60° C. for degassing; raising the temperature after degassing; keeping the temperature at 98° C. for sterilization and inactivation of enzymes; after 30 seconds, it was cooled to bring the temperature of the fruit juice to 15° C. At this temperature of 15° C., the processed orange juice was tasted and examined, and the results showed obvious bitterness upon drinking, and obvious stewing odor was emitted during placement, the sugar-acid ratio was 20:1, and the pH was 3.65.

### Example 3

### Orange Juice Obtained from Another Orange, Hamlin Orange

The same method as in Comparative Example 1 was used, except that the navel orange was replaced by another orange, a Hamlin orange. The results showed that the sugar-acid ratio of the obtained orange juice was 11:1, and the pH was 3.32. It can be seen from the above Comparative Example 1 that following conventional method for orange processing, navel oranges cannot be processed into orange juice suitable for industrial scale.

Throughout the foregoing description, for the purposes of explanation numerous specific details were set forth in order to provide a thorough understanding of the invention. It will be apparent, however, to one skilled in the art that the invention may be practiced without some of these specific details. Although various embodiments which incorporate the teachings of the present invention have been shown and described in detail herein, those skilled in the art can readily devise many other varied embodiments that still incorporate these techniques. Embodiments of the invention may include various operations as set forth above or fewer operations or more operations; or operations in an order, which is different from the order described herein. Accordingly, the scope and spirit of the invention should be judged in terms of the claims which follow, as well as the legal equivalents thereof.

1. A method for producing a citrus fruit raw juice or the concentrate thereof comprising:
a) squeezing a citrus fruit with a squeezer to produce a citrus fruit raw juice, while simultaneously adding an acid harmless to humans so that the squeezed citrus fruit raw juice has a total acid content of 0.85-1.0 wt %; and
b) heating the citrus fruit raw juice obtained in (a) above at 75° C.±5° C. to 80° C.±2° C. for 30+10 to 60±5 seconds to obtain a citrus fruit raw juice substantially free of bitterness and free of unfavorable odor having a sugar-acid ratio of 14:1 to 18:1 and a pH of 3.4-3.1.

2. The method according to claim 1, further comprising: further concentrating the citrus fruit raw juice in (b) according to a conventional method to a volume that is ½- 1/10 of the volume of the citrus fruit raw juice to obtain a concentrate of citrus fruit juice.

3. The method according to claim 1, further comprising: further concentrating the citrus fruit raw juice in (b) according to a conventional method to a volume that is ½-⅙ of the volume of the citrus fruit raw juice to obtain a concentrate of citrus fruit juice.

4. The method according to claim 1, further comprising: further concentrating the citrus fruit raw juice in (b) according to a conventional method to a volume that is ¼-⅙ of the volume of the citrus fruit raw juice to obtain a concentrate of citrus fruit juice.

5. The method according to claim 1, wherein the acid harmless to humans is an acid allowed to be added in food industry.

6. The method according to claim 1, wherein the acid harmless to humans includes citric acid or malic acid.

7. The method according to claim 1, further comprising using the citrus fruit raw juice or concentrate thereof in the production of an edible product.

8. A citrus fruit raw juice or the concentrate thereof, which is prepared by claim 1.

9. A citrus fruit raw juice or the concentrate thereof, which is prepared by claim 2.
